(19) United States
(12) Patent Application Publication
(10) Pub. No.: US 2014/0250690 A1
(43) Pub. Date: Sep. 11, 2014

(54) INCREMENTAL MANDIBULAR ADVANCEMENT

(71) Applicant: Sleep Science Partners, Inc., Larkspur, CA (US)

(72) Inventor: Noel Lindsay, Ross, CA (US)

(73) Assignee: Sleep Science Partners, Inc., Larkspur, CA (US)

(21) Appl. No.: 14/199,809

(22) Filed: Mar. 6, 2014

Related U.S. Application Data
(60) Provisional application No. 61/773,593, filed on Mar. 6, 2013.

(51) Int. Cl. A61C 7/00; A61C 7/08

(52) U.S. Cl. CPC A61C 7/002; A61C 7/08
USPC 29/896.1

(57) ABSTRACT

A plurality of non-adjustable mandibular repositioning devices (MRDs) providing incremental advancement are prescribed and manufactured for a patient. A patient's mouth and teeth and other areas may be measured and modeled, for example, using an intra-oral three-dimensional modeling method. A series of MRDs may be manufactured such that each MRD repositions the mandible a different amount. A patient uses the first MRD for a first period of time, and uses one or more of the remaining MRDs in succession to provide mandibular advancement. The series of MRDs are not adjusted or installed by a health professional, making each MRD usage less expensive.

### CROSS REFERENCE TO RELATED APPLICATIONS

This application claims the priority benefit of U.S. Provisional Application Ser. No. 61/773,593, titled “Incremental Mandibular Advancement,” filed Mar. 6, 2013, the disclosure of which is incorporated herein by reference.

### BACKGROUND

Mandibular repositioning devices (MRD) are used to reposition a patient's mandible. Typically, an MRD is created by a physician, dentist or other health provider. The health professional examines the patient and collects information about the patient. The MRD is then generated based on the needs of the patient and the patient measurements.

Because the MRD is designed to reposition the patient's mandible to the most beneficial position particular to that patient, the MRD is typically adjusted to move the mandible to an optimum position. Adjustment is usually done by the health professional. The adjustment may be made when the user brings in the MRD to the health professional's office. Though this assures a proper adjustment, it is inconvenient for a patient to bring in an MRD to a health professional when an adjustment is needed.

What is needed is an improved MRD device that is more convenient for a user.

### SUMMARY

In an embodiment, a plurality of mandibular repositioning devices (MRDs) providing incremental advancement are prescribed and manufactured for a patient for a single episode of mandibular repositioning. A patient's mouth and teeth may be modeled, for example using an intra-oral three-dimensional modeling method. A series of MRDs may be manufactured such that each MRD repositions the mandible a different amount. The MRDs may have any design, but are manufactured to have different offsets in mandibular positioning. The plurality of MRDs is provided to a user, along with instructions to use the MRDs in a manner prescribed by the health professional. For example, a patient might use a first MRD for a first period of time, such as two weeks and after the two week period, the patient may be instructed to try a sequential MRD, and so on, until the MRD that provides the most advancement without not causing unacceptable discomfort is found. The series of MRDs of the present invention are not adjusted or installed by a health professional, such as a dentist, and therefore the process of obtaining an MRD with optimum mandibular advancement may be accomplished less expensively and in a manner that is more convenient for the patient.

### BRIEF DESCRIPTION OF DRAWINGS

FIG. 1 illustrates a separated upper and lower component of a mandibular repositioning device.

FIG. 2 illustrates engaged upper and lower components of a mandibular repositioning device with initial mandibular advancement.

FIG. 3 illustrates engaged upper and lower components of a mandibular repositioning device with additional first incremental mandibular advancement.

FIG. 4 illustrates engaged upper and lower components of a mandibular repositioning device with subsequent first incremental mandibular advancement.

FIG. 5 is a method for manufacturing a plurality of mandibular repositioning devices.

### DETAILED DESCRIPTION

A plurality of mandibular repositioning devices (MRDs) which provide incremental advancement may be prescribed and manufactured for a patient for a single episode of mandibular repositioning. A patient's mouth and teeth may be modeled, for example using an intra-oral three-dimensional modeling method. The MRDs may be manufactured such that each MRD repositions the mandible a different amount. The plurality of MRDs is provided to a user, along with instructions to use the MRDs in a manner prescribed by the health professional. A patient might use a first MRD for a first period of time, such as two weeks. After the two week period, the patient may be instructed to try a sequential MRD, and so on, until the MRD that provides the most advancement without causing unacceptable discomfort is found, or some other method may be used to determine which MRD provides an optimum amount of mandibular advancement.

An MRD for use with the present technology may have any design, but may be manufactured to have different offsets in mandibular positioning. The series of MRDs of the present invention are not adjusted or installed by a health professional, such as a dentist. Therefore the process of obtaining an MRD with optimum mandibular advancement may be accomplished less expensively and in a manner that is more convenient for the patient.

The present technology achieves incremental mandibular advancement without requiring adjustment of any single MRD. Rather, an MRD is replaced with another MRD which has an incremental change in the mandibular position. Hence, rather that require adjustment by a patient or health professional, the patient may simply replace an MRD currently in place with another MRD in the series of MRDs that provides an incremental mandibular movement.

An MRD is referred to and illustrated herein for purposes of example only. The present technology may be applied to any type or design of mandibular repositioning device, mandibular advancement splint (MAS), mandibular advancement device (MAD), intraoral device, and other dental devices.

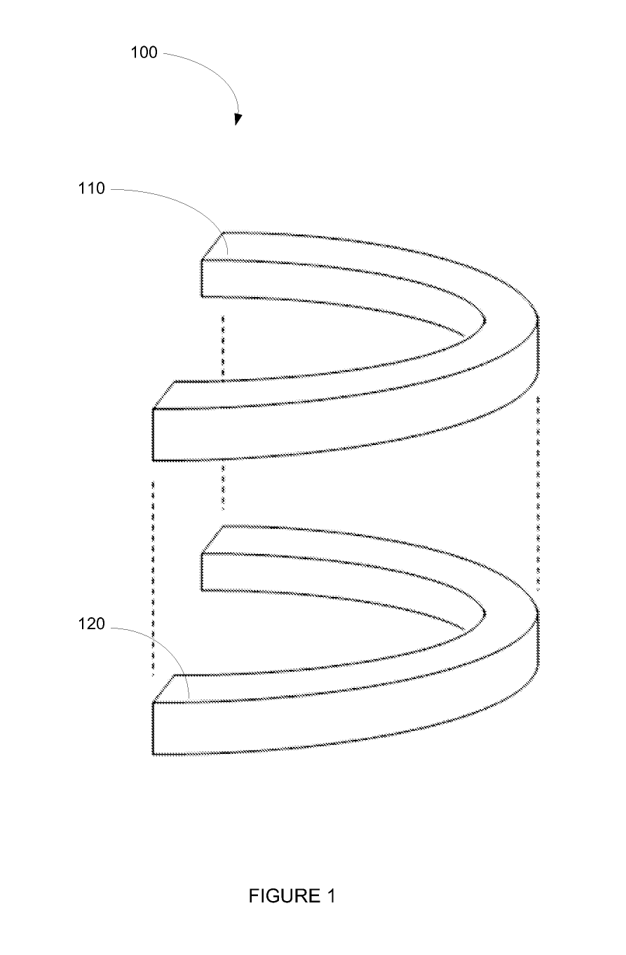

FIG. 1 illustrates a separated upper and lower component of a mandibular repositioning device. The MRD 100 of FIG. 1 includes upper component 110 and lower component 120. Upper component 110 may be worn by a patient over the teeth of the upper jaw in a patient's mouth. Lower component 120 may be worn by a patient over the teeth of the lower jaw or mandible of the patient's mouth. The upper component 110 and lower component 120 may be created from an intra-oral scan or other modeling method of the user's mouth. The scan or other modeling method should produce measurements of the upper and lower teeth, mandibular position, and other data. The measurements should allow for creation of a plurality of MRDs which fit the user's upper and lower jaw and collectively provide for incremental mandibular advancement, where each MRD provides an incremental change in position of the mandibular.

Data from which the MRDs may be created may include measurements of the relative position and orientation of the upper arch and lower arch within the patient's mouth. The measurements may include the natural position of the upper and lower arch and other data. The measurements may be collected from a health professional such as a dentist through a registration process or other process. The measurements may represent the internal topography of the patient's mouth so as to enable an MRD manufacturer to create MRDs that contain the correct amount of successive advancement. With these measurements, an MRD can be manufactured such that the upper and lower portion fit the particular patient and may be interconnected to provide minimal advancement when titration mechanisms are not advanced. The data may also include the shape, orientation and position of the patient's teeth as well as the shape of soft tissue within the patient's mouth.

The interconnection of the MRDs may be made in any of several ways. For example, the MRDs may be combined using components and technologies that allow a user to open and move their jaw in a lateral direction while the device remains engaged with the user's teeth. Other existing technologies may be used with the MRDs described herein as well. Additionally, some elements disclosed herein need not be present in all embodiments of the MRDs. For example, in addition to designing the series of MRDs such that they already fit the teeth and gums of the patient based at least in part on collected data, MRDs may also be constructed as a series of MRDs that may be “self-molded” to the teeth. Users may fit an MRD device to their teeth by immersing it in boiling hot water to soften some plastic, remove it from the water for a specified period of time to allow it to cool, insert the device into the mouth, and bite down to make an impression in the softened plastic, much in the same way as an athletic mouthguard. In this instance, each MRD device may have progressively more mandibular advancement than the previous one.

Additionally, a version of the present technology may be similar to the one above but which is neither designed to fit the users teeth nor is it “self-molded” to the user's teeth. In essence, it would just be a series of MRDs which generically fit over the upper and lower arches without being fitted in any way to the teeth and gums, yet each device in this series would have progressively more mandibular advancement than the previous one. In this instance of the present technology, there is no need for the device to be designed or manufactured to fit the shape of the particular user's teeth and gums

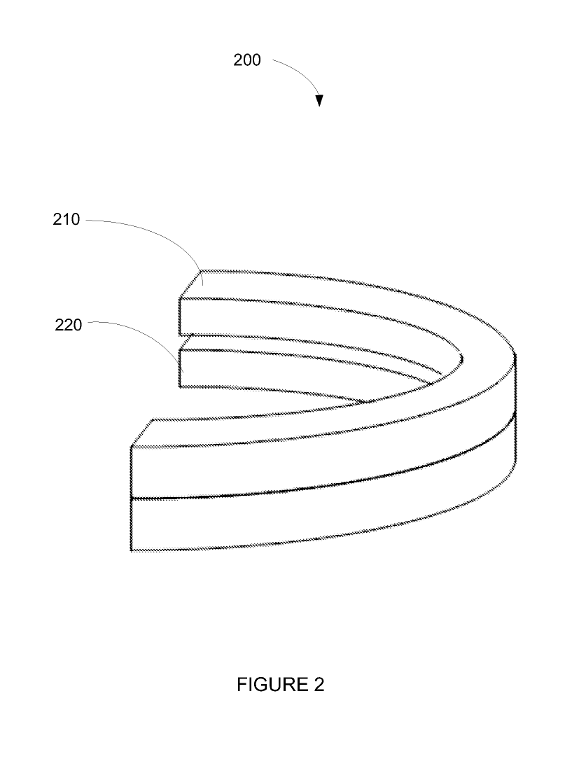

FIGS. 2-4 illustrate upper and lower components of an MRD which provide different levels of mandibular advancement. FIG. 2 illustrates engaged upper and lower components of a mandibular repositioning device with initial mandibular advancement. Upper component 210 and lower component 220 of MRD 200 in FIG. 2 engage each other to provide an initial mandibular advancement. In some embodiments, a plurality of a MRDs, each consisting of an upper component and a lower component, are provided to a user. Each of the plurality of MRDs may provide a different level of mandibular advancement, from an initial amount to a desired amount. The desired amount may be a level of advancement intended to achieve by a health professional after examining a user or reviewing the user's intra oral examination or modeling data.

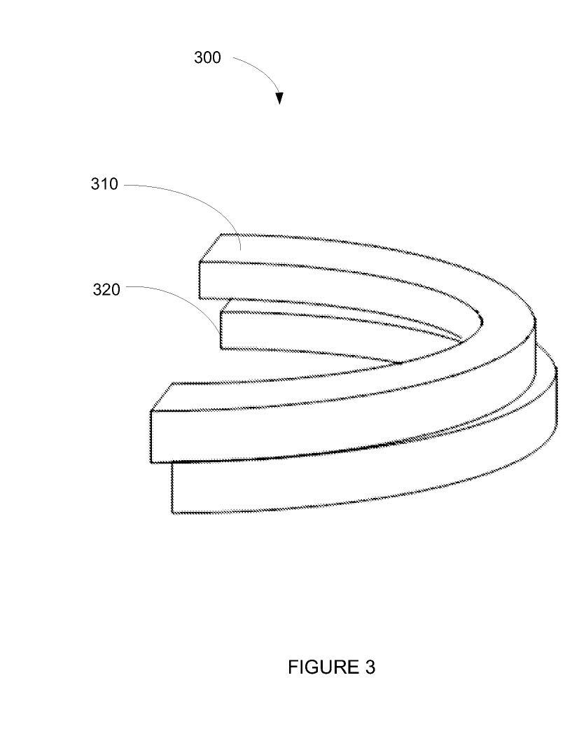

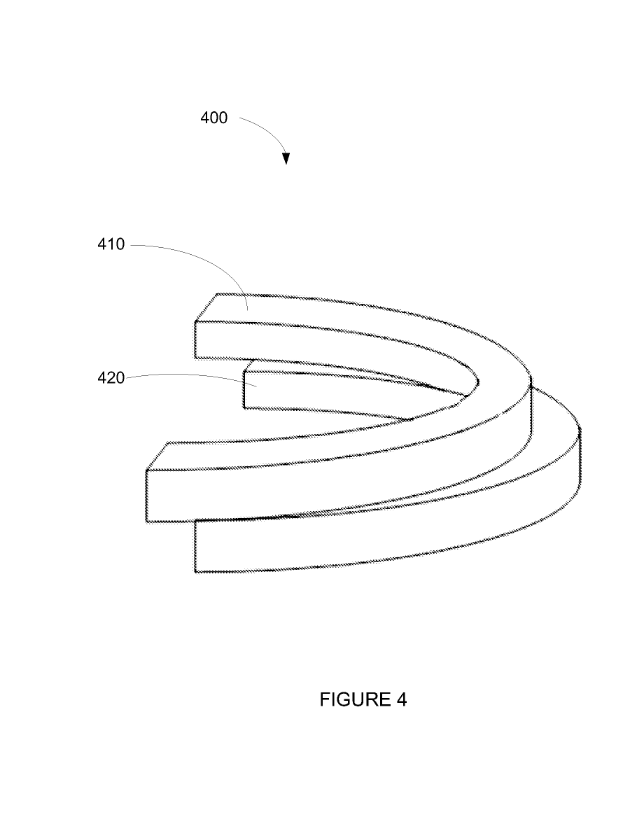

FIG. 3 illustrates engaged upper and lower components of a mandibular repositioning device with additional first incremental mandibular advancement. Upper component 310 and lower component 320 of MRD 300 in FIG. 3 engage each other to provide a level of mandibular advancement which is greater than MRD 200 of FIG. 2. FIG. 4 illustrates engaged upper and lower components of a mandibular repositioning device with subsequent first incremental mandibular advancement. Upper component 410 and lower component 420 of MRD 400 in FIG. 4 engage each other to provide a level of mandibular advancement which is greater than MRD 300 of FIG. 3.

The amount of mandibular advancement provided for a patient may vary based on the patient's particular needs. The amount of mandibular advancement illustrated between MRDs 200, 300 and 400 is exaggerated for purposed of illustration, and may provide more advancement than the amount of advancement that would actually take place in actual use. In some embodiments, the sequential increase in mandibular advancement may be on the order of one millimeter, but may vary. In some embodiments, the incremental amount of advancement might vary as the patient progresses through each successive MRD of the plurality of MRDs created for the patient.

For example, there may be quite a lot of incremental advancement when transitioning from a first MRD to a second MRD created for a patient, and less incremental advancement when transitioning from the second MRD to the third MRD. In some embodiments, there may be a small incremental advancement between the first two MRDs and a lot of incremental advancement between the second and third MRD. The specific sequence of incremental advancement may be based on a patient's condition, the device used, and the preference of the health professional.

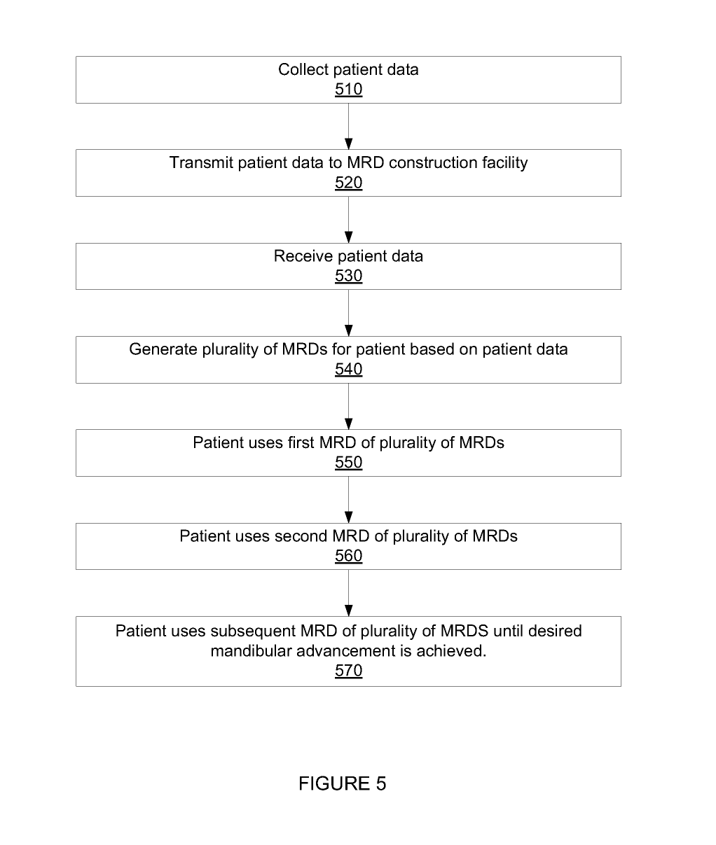

FIG. 5 is a method for manufacturing a plurality of mandibular repositioning devices. First, data for a patient's upper and lower jaw is collected at step 510. The data may result from an intra-oral scan which collects data representing the patient's mouth and teeth. The data may also be collected from a mold of the patient's teeth, x-ray, or other technique which provides position information for the patient's teeth, mandible, and other portions of the patient's mouth. The data may also include an actual position of the patient mandible and a desired position of the mandible.

The patient data is then transmitted to an MRD construction facility at step 520. The patient data is received by the construction facility at step 530. The construction facility may be offsite from a health professional who collects the data, or may be a machine located in the same location as the health professional.

A plurality of MRDs are generated at step 540. The MRDs may be generated such that the upper portion and lower portion of the MRD is fit to the patient's upper and lower jaw, respectively, and may be engaged to provide different levels of mandibular advancement. For example, a first MRD in the plurality of MRDs may provide a first amount of mandibular advancement, a second MRD in the plurality of MRDs may provide an additional amount of mandibular advancement, and so forth.

The patient uses the first MRD by wearing the first MRD of the plurality of MRDs at step 550. After a specified period of time, the patient may then use the second MRD (or next MRD to be worn) in the plurality of MRDs at step 560. The plurality of MRDs may be worn by the patient in turn for a period of time as determined by a health professional, the MRD manufacturer, or other source. By wearing the series of MRDs over time, replacing each of MRD with a subsequent MRD that provides more mandibular advancement than the previous one, the position of the patient's mandible may be advanced until a desired position is achieved at step 570.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for manufacturing a plurality of devices for adjusting the position of a patient mandible, comprising:
receiving data for a patient, the data including a relative position between the upper arch and lower arch of the patient's mouth, the data further including the shape of the patient's teeth and soft tissue;
creating by a manufacturing system a plurality of devices for adjusting the position of the mandible, each device being non-adjustable and intended to be used by the patient associated with the data in a predetermined order,
wherein each device of the plurality of devices provides for a different amount of mandibular advancement.

2. The method of claim 1, wherein the relative position of the upper arch and lower arch of the patient's mouth is acquired through a registration process performed by a health professional.

3. The method of claim 1, wherein the data includes prescription data generated by a health professional.

4. The method of claim 1, wherein the device is a mandibular repositioning device (MRD).

5. The method of claim 1, wherein the device includes an upper portion and a lower portion that engage each other, the device providing an amount of mandibular advancement when the upper portion and lower portion are engaged.

6. The method of claim 1, wherein the data further includes the orientation and position of the patient's teeth.
